(19) United States
(12) Patent Application Publication
(10) Pub. No.: US 2014/0175916 A1
(43) Pub. Date: Jun. 26, 2014

(54) ROTOR ASSEMBLY HAVING LIQUID COOLING

(71) Applicant: REMY TECHNOLOGIES, LLC, Pendleton, IN (US)

(72) Inventors: Bradley D. Chamberlin, Pendleton, IN (US); Colin Hamer, Noblesville, IN (US)

(73) Assignee: REMY TECHNOLOGIES, LLC, Pendleton, IN (US)

(21) Appl. No.: 13/721,856

(22) Filed: Dec. 20, 2012

(51) Int. Cl. H02K 9/19

(52) U.S. Cl. CPC H02K 9/19
USPC 310/54

(57) ABSTRACT

A liquid-cooled rotor assembly for a rotary electric machine, including a shaft provided with a fluid passageway receivable of a liquid coolant, and a substantially cylindrical rotor core rotatable in unison with the shaft. The rotor core is provided with a plurality of passages each terminating at a void in a rotor core axial end. Permanent magnets are disposed in rotor core passages, a gap is defined between each magnet and its respective rotor core passage. The shaft fluid passageway is in fluid communication with the rotor core end voids through the gaps, whereby the rotor core and the magnets are convectively cooled by liquid coolant receivable by the shaft fluid passageway and delivered to a rotor core end through the rotor core passages. Also, a method for liquid cooling a rotor assembly.

### BACKGROUND

The present disclosure relates to rotary electric machines, such as electric generators and motors, and particularly to rotary electric machines of the type having permanent magnets carried by the machine rotor.

In permanent magnet rotary electric machines, recent material developments have resulted in machines being operated at increased internal temperatures. Most machine components, e.g., the conductors, suitably perform at such levels. Currently, however, the performance of such machines is compromised by the limited performance of their permanent magnets at elevated temperatures. When a permanent magnet temperature reaches a certain level, it demagnetizes, resulting in a performance loss in or failure of the machine. To keep the magnets suitably cool, a liquid coolant such as oil is often supplied to locations proximate to the magnets. In certain prior machine designs, a liquid coolant such as oil, for example, is supplied to the center of the rotor shaft and holes are cross-drilled through the rotor assembly to divert the oil from the shaft through the rotor core and convectively cool the rotor assembly. The cross-drilling of the holes represents an additional operation and consequent cost to the manufacture of electric machines.

Rotor cores are typically formed of stacked, electrical steel laminae that are welded or otherwise interlocked together into a substantially cylindrical form, with the permanent magnets carried by the lamina stack. The rotor core lamina stack is often provided with axially-directed holes defined by aligned apertures in the laminae, in which the magnets are disposed. Gaps defined between the internal walls of the holes and the magnets are typically filled with a thermally conductive resin. The rotor core may be fixed to a hub, and the hub may be fixed to a rotatable shaft, thus defining the rotor assembly of a rotary electric machine. As noted above, the shaft may be provided with liquid coolant, and holes may be cross-drilled through the rotor core, hub and shaft to divert the oil through the rotor assembly, and convectively cool the lamina stack. The magnets are conductively cooled through their contact with internal walls of the rotor core passages, directly or through the thermally conductive resin. The prior means of magnet cooling, which entails convectively cooling the lamina stack and conductively cooling the magnets, is less than optimal.

A structure and method for providing improved cooling of the permanent magnets in a rotary electric machine, by which machine performance can be enhanced, and which avoid cross-drilling operations and their attendant costs, would be desirable advancements in the relevant art.

### SUMMARY

In accordance with the present disclosure, liquid coolant from a shaft passageway is received into the rotor core from a radially inward location, and is conducted generally axially through passages in the rotor core, along the lengths of permanent magnets disposed in the rotor core passages. Liquid coolant is urged into the rotor core passages from radially inwardly of the rotor core via a space in fluid communication with the shaft fluid passageway. The liquid coolant is fed through a hub disposed radially between the shaft and the rotor core, and into distribution lamina, which defines radially extending trunks in the rotor core. The distribution lamina is disposed between, and axially spaces, a pair of stacks of annular electrical steel laminae. Each lamina stack carries permanent magnets in branches extending generally axially through the rotor core. The branches that extend generally axially through each lamina stack are fluidly connected to the trunks.

Permanent magnets are disposed in at least some of the branches, and define gaps through which the liquid coolant flows. The liquid coolant travels along the branches and reaches the axial ends of the rotor via voids which define branch openings. At this point, the liquid coolant exiting each rotor core axial end enters a manifold collection space defined by a balance ring affixed to the respective rotor core axial end. The manifolds are provided with exit nozzles from which liquid coolant exits the rotor assembly. The exit nozzles are sized such that they define pressure controlled orifices. The flow restrictions of the orifices ensure that the liquid cooling system volume inside the rotor assembly remains effectively full of liquid coolant, and that the coolant within the cooling system volume remains pressurized, during machine operation.

Beneficially, heat generated within the rotor assembly, particularly its magnets, and from other machine losses, is convectively transferred to the liquid coolant and is removed with the flow of liquid coolant from the rotor assembly and the machine. The improved cooling capability results in the availability of higher machine power output, or the ability to reduce the size of the machine.

The present disclosure provides a liquid-cooled rotor assembly for a rotary electric machine. The rotor assembly includes a rotatively-supportable shaft defining a central axis about which the rotor assembly is rotatable, the shaft provided with a fluid passageway receivable of a liquid coolant. The rotor assembly also includes a substantially cylindrical rotor core disposed about the central axis and rotatable in unison with the shaft. The rotor core has axially opposite ends, and the rotor core is provided with a plurality of passages, each rotor core passage terminating at a void in a rotor core axial end. A plurality of permanent magnets is distributed about the central axis, each of these magnets disposed in a rotor core passage. A gap is defined between each magnet and its respective rotor core passage, and the shaft fluid passageway is in fluid communication with the rotor core end voids through the gaps, whereby the rotor core and the plurality of magnets are convectively cooled by liquid coolant receivable by the shaft fluid passageway and delivered to a rotor core end through the rotor core passages.

A further aspect of this disclosure is that the shaft fluid passageway has a generally axially-extending first leg and at least one generally radially-extending second leg, the first leg and a rotor core end void in fluid communication through the second leg. Liquid coolant receivable into the shaft fluid passageway first leg is urged from the shaft fluid passageway through the shaft fluid passageway second leg and towards the rotor core passage by rotation of the rotor assembly about the central axis.

A further aspect of this disclosure is that a hub is disposed radially between and interconnecting the shaft and the rotor core. The hub is provided with a fluid duct through which the shaft fluid passageway and a rotor core passage are fluidly connected.

A further aspect of this disclosure is that the hub fluid duct has a generally radially-extending portion along which liquid coolant receivable into the hub fluid duct is urged towards the rotor core by rotation of the rotor assembly about the central axis.

A further aspect of this disclosure is that one of the shaft and the hub is provided with a circumferentially-extending groove through which the hub fluid duct and the shaft fluid passageway are fluidly connected.

A further aspect of this disclosure is that the hub is provided with a plurality of fluid ducts, each hub fluid duct in fluid communication with the groove. Liquid coolant receivable into the groove from the shaft fluid passageway is distributable to the plurality of rotor core passages through the plurality of hub fluid ducts.

A further aspect of this disclosure is that the plurality of rotor core passages is distributed about the central axis.

A further aspect of this disclosure is that each magnet of the plurality of magnets is elongate and entirely surrounded about its length by its respective rotor core passage.

A further aspect of this disclosure is that a rotor passage includes a generally radially-extending trunk and a generally axially-extending branch, a magnet disposed in a rotor core branch.

A further aspect of this disclosure is that, relative to a rotor core passage, the trunk and the void are fluidly connected with each other through the branch.

A further aspect of this disclosure is that a multiplicity of rotor core passages includes a multiplicity of branches and a common trunk to which the multiplicity of branches is fluidly connected.

A further aspect of this disclosure is that a rotor core passage includes a multiplicity of trunks and a common branch with which the multiplicity of trunks is fluidly connected.

A further aspect of this disclosure is that the common branch has an inlet opening fluidly connected to each trunk of the multiplicity of trunks.

A further aspect of this disclosure is that the common branch is devoid of a magnet.

A further aspect of this disclosure is that the rotor core includes an axially-stacked plurality of carrier laminae each mutually adjacent to another of the plurality, and at least one distribution lamina axially adjacent the plurality of carrier laminae. The plurality of carrier laminae define a plurality of branches. A plurality of trunks is defined by at least one distribution lamina and at least one carrier lamina.

A further aspect of this disclosure is that the plurality of carrier laminae defines at least one branch devoid of a magnet.

A further aspect of this disclosure is that at least one distribution lamina is disposed between a first plurality of carrier laminae and second plurality of carrier laminae.

A further aspect of this disclosure is that the plurality of trunks is defined by the first and second pluralities of carrier laminae and at least one distribution lamina.

A further aspect of this disclosure is that the plurality of trunks is defined between axially interfacing surfaces of the first and second pluralities of carrier laminae.

A further aspect of this disclosure is that at least one distribution lamina defines an axial spacer interposed between the first and second pluralities of carrier laminae. Each of a pair of branches respectively defined by the first and second pluralities of carrier laminae are substantially aligned with each other, and the pair of aligned branches is fluidly connected to a common trunk partially defined by the spacer, whereby both of the pair of aligned branches are receivable of liquid coolant conducted substantially radially along the common trunk.

A further aspect of this disclosure is that flows of liquid coolant are receivable by a plurality of common trunks and are substantially equal portions of the flow of liquid coolant from the shaft fluid passageway receivable by the plurality of rotor core passages.

A further aspect of this disclosure is that a flow of liquid coolant receivable into one common trunk of the plurality of common trunks, is receivable in substantially equal portions by branches defined in the first plurality of carrier laminae and branches defined in the second plurality of carrier laminae.

A further aspect of this disclosure is that the rotor assembly includes a manifold disposed about the central axis and sealed to a rotor core end. The manifold defines a collection space into which liquid coolant is receivable from the rotor core end voids. The shaft fluid passageway and the collection space are in fluid communication with each other through the plurality of rotor core passages.

A further aspect of this disclosure is that a rotor core end void defines one of a plurality of liquid coolant inlets to the collection space, the manifold having at least one outlet from which liquid coolant is expelled from the collection space.

A further aspect of this disclosure is that the total size of the at least one manifold outlet is smaller than the total size of the plurality of inlets to the manifold, whereby the manifold may be pressurized with liquid coolant receivable therein.

A further aspect of this disclosure is that the rotor core passages remain pressurized with liquid coolant flowed therethrough during rotation of the rotor assembly, whereby the rotor core passages may remain full of liquid coolant receivable therein during rotation of the rotor assembly.

A further aspect of this disclosure is that each manifold outlet is a pressure controlled orifice, whereby spaces for liquid coolant in the rotor assembly may remain full of liquid coolant during rotation of the rotor assembly.

A further aspect of this disclosure is that the manifold defines a balance ring rotatable in unison with the shaft.

The present disclosure also provides a rotary electric machine including a rotor assembly as described above, and a stator assembly, the rotor assembly surrounded by and rotatable relative to the stator assembly.

The present disclosure also provides a method for liquid cooling a rotor assembly in a rotary electric machine, including: receiving liquid coolant into a fluid passageway located in a shaft of the rotor assembly; rotating a substantially cylindrical rotor core of the rotor assembly and the shaft in unison about an axis; urging liquid coolant radially outwardly of the shaft and into an internal passage extending through the rotor core; directing liquid coolant received into the rotor core passage, through a gap defined by a permanent magnet disposed in the rotor core passage and an internal wall of the rotor core passage surrounding the magnet, and out of the rotor core; and convectively cooling the rotor core and the permanent magnet with liquid coolant directed through the gap.

A further aspect of this disclosure is that the method includes providing a hub radially between the shaft and the rotor core, and fluidly connecting the shaft fluid passageway and the rotor core passage through a fluid duct in the hub.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 is a fragmented, partial, cross-sectional view of a rotary electric machine, the section taken generally along line 1-1 of FIG. 3;

FIG. 2 is a fragmented, partial, cross-sectional view of the rotor core of the electric machine, along line 2-2 of FIG. 4;

FIG. 3 is a fragmented, partial, cross-sectional view of the rotor core of the electric machine, along line 3-3 of FIG. 4; and

FIG. 4 is an enlarged view of encircled area 4 of FIG. 1.

Corresponding reference characters indicate corresponding parts throughout the several views. Although the drawings represent an embodiment of the disclosed device and method, the drawings are not necessarily to scale or to the same scale and certain features may be exaggerated in order to better illustrate and explain the present disclosure. Moreover, in accompanying drawings that show sectional views, cross-hatching of various sectional elements may have been omitted for clarity. It is to be understood that any omission of cross-hatching is for the purpose of clarity in illustration only.

### DETAILED DESCRIPTION

The embodiment of the present disclosure is not intended to be exhaustive or to limit the invention to the precise form disclosed in the following detailed description. Rather, the embodiment is chosen and described so that others skilled in the art may appreciate and understand the principles and practices of the present disclosure.

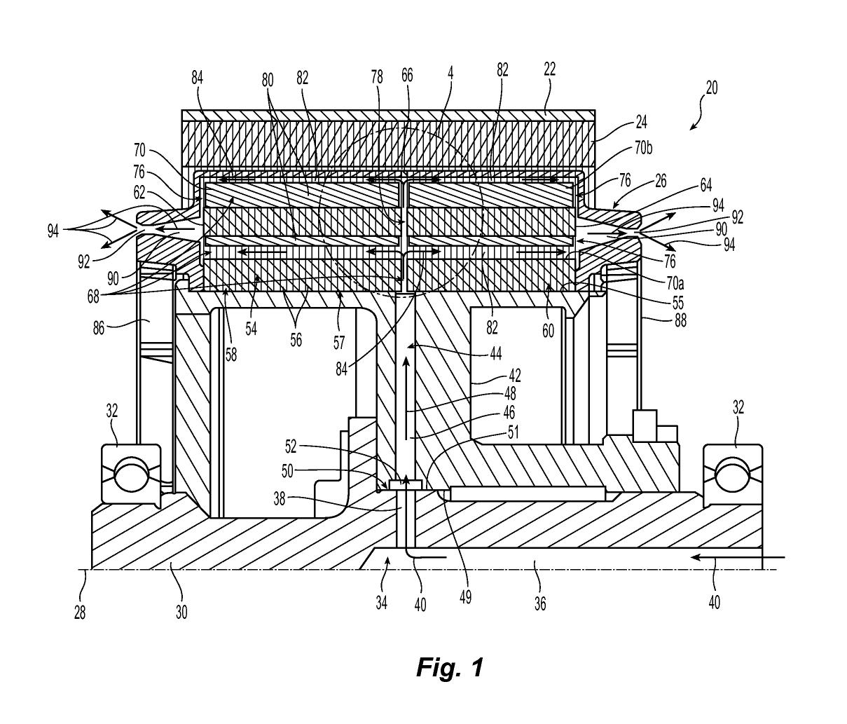

Referring to FIG. 1 there is shown rotary electric machine 20 having housing 22 within which is affixed annular stator assembly 24 of a type well known in the art. Disposed within and surrounded by stator assembly 24 is cylindrical rotor assembly 26. Housing 22, stator assembly 24, and rotor assembly 26 are concentric about central axis 28. Rotor assembly 26 comprises shaft 30 rotatively supported by bearings 32, which are supported by housing 22. Rotor assembly 26 is rotatable relative to stator assembly 24 about central axis 28.

Shaft 30 includes a fluid passageway 34, a portion of which is shown in FIG. 1. Shaft fluid passageway 34 includes first, axial leg 36 into which flows a liquid coolant introduced to the fluid passageway 34 from outside of housing 22, and at least one second, radial leg 38 that is fluidly interconnected to first, axial leg 36 of fluid passageway 34. Fluid passageway 34 may include a plurality of second, radial legs 38 equiangularly distributed about axis 28. The rotation of rotor assembly 26 is induced mechanically by torque applied from outside of housing 22, as in a generator, or electromagnetically as by a torque applied through its operative electromagnetic interaction with stator assembly 24, as in a motor.

Regardless, the rotation of rotor assembly 26 imparts centrifugal forces to the liquid coolant within shaft fluid passageway 34, which forces the coolant radially outwardly under pressure from shaft 30 through second, radial leg(s) 38. Liquid coolant is continually replenished to axial, first leg 36 from outside of housing 22, thereby ensuring that shaft fluid passageway 34 remains filled with liquid coolant during operation of machine 20. The continuous flow of liquid coolant through fluid passageway 34 is indicated by arrows 40 shown in FIG. 1.

Fixed to shaft 30 and rotatable in unison therewith is hub 42 of rotor assembly 26. Hub 42 is provided with a plurality of fluid ducts 44, one of which is shown in FIG. 1. Each hub fluid duct 44 receives liquid coolant delivered under pressure from shaft fluid passageway 34 during rotation of the rotor assembly 26. Each fluid duct 44 includes a radially-extending portion 46 that is fluidly connected to shaft fluid passageway 34, and the liquid coolant received into hub fluid ducts 44 is urged radially outwardly along duct portion(s) 46 by the centrifugal forces generated through the rotation of shaft 30 and hub 42, the centrifugal forces acting on the coolant within the shaft and hub and pressurizing the cooling system volume. The flow of liquid coolant through the radially extending portion(s) 46 of the fluid duct(s) 44 is indicated by arrow 48 in FIG. 1.

Radially inner cylindrical surface 49 of hub 42 forms circumferential sealed joints 50 with radially outer cylindrical surface 51 of shaft 30. As shown in FIG. 1, sealed joints 50 are located on axially opposite sides of circumferential groove 52 formed in hub radially inner cylindrical surface 49, into which liquid coolant is received from second, radial leg(s) 38 of shaft fluid passageway 34. Groove 52 is provided to facilitate the equal distribution of liquid coolant received from second, radial leg(s) 38 amongst the plurality of fluid ducts 44 without necessitating a particular radial alignment between each second, radial leg 38 of the shaft fluid passageway 34 and a hub fluid duct 44. Thus, the number of second legs 38 and fluid ducts 44 need not be identical. Those of ordinary skill in the art will recognize that circumferential groove 52 may instead or additionally be provided in shaft radially outer cylindrical surface 51 between circumferential sealed joints 50.

Rotor assembly 26 further includes annular rotor core 54 affixed to the radially outer cylindrical surface 55 of hub 42. Rotor core 54 comprises a stack of concentric, annular, radially-aligned carrier laminae 56 welded to or otherwise interlocked with one another in a manner known in the art. Carrier laminae 56 may be identical and each stamped, for example, from electrical steel sheet material. Each annular carrier lamina 56 has circular, radially inner edge 57 that fixedly engages hub surface 55 in a known manner. For example, rotor core 54 may be welded or interference fitted to hub 42. Each annular carrier lamina 56 also has a circular outer edge 59 that interfaces and is radially spaced from the cylindrical bore of stator assembly 24.

Rotor core 54 has a cylindrical shape formed by a first stack 58 of carrier laminae 56, and a coaxial second stack 60 of carrier laminae 56. The cylindrical first and second lamina stacks 58 and 60 may be identical, and are radially aligned, as described further below, about central axis 28. The first and second stacks 58, 60 of carrier laminae 56 respectively define first axial end 62 and opposed second axial end 64, of rotor core 54. Centrally disposed between the rotor core first and second axial ends 62, 64 is at least one distribution lamina 66 which is welded to or otherwise interlocked with the first and second lamina stacks 58, 60. Thus, the first and second carrier lamina stacks 58, 60 are axially spaced by, and radially aligned with, distribution lamina 66, which is also referred to as spacer 66. Distribution lamina 66 is annular, concentric with carrier laminae 56, and has circular, radially outer edge 67 that is flush with carrier laminae edges 59. Distribution lamina 66 may, for example, also be stamped from electrical steel sheet material.

Rotor core 54 is provided with a plurality of interior passages 68 which are fluidly connected to the fluid ducts 44 of hub 42. Liquid coolant received into passages 68 from fluid ducts 44 is conducted through the passages 68 for the purposes of convectively cooling the rotor assembly 26, and particularly the rotor core 54 and permanent magnets carried thereby, which are discussed further below. Each of the plurality of passages 68 includes a generally axially extending branch 70 defined by aligned apertures provided in the carrier laminae 56 of the first and second lamina stacks 58, 60. The branches 70 in first lamina stack 58 extend from its inner axial surface 72, which abuts one axial side of spacer 66, to the first axial end 62 of rotor core 54. The branches 70 in second lamina stack 60 extend from its inner axial surface 74, which abuts the opposite axial side of spacer 66, to the second axial end 64 of rotor core 54. Each branch 70 terminates in a void 76, which may be an enclosed opening defined by one of the branch-defining apertures formed in the carrier lamina 56 that establishes a rotor core axial end 62 or 64.

Spacer 66 and the abutting, inner axial surfaces 72 and 74 of the first and second lamina stacks 58, 60 define a plurality of radially extending trunks 78 that each receive liquid coolant under pressure from fluid ducts 44 of hub 42 during operation of machine 20. In a manner similar to that discussed above regarding the fluid interconnection between shaft fluid passageway second leg(s) 38 and hub fluid ducts 44, the cylindrical interface between rotor core 54 and hub 42 may include a circumferential groove 79 axially bordered by circumferential, sealed joints (not shown). Groove 79 facilitates the equal distribution of liquid coolant amongst all trunks 78, without necessitating a radial alignment between each trunk 78 and a hub fluid duct 44, or that the number of trunks 78 and fluid ducts 44 be identical. In the depicted embodiment, groove 79 is shown located in hub radially outer cylindrical surface 55 (FIGS. 1, 4). Those of ordinary skill in the art will recognize that a circumferential groove 79 may instead or additionally be provided in the radially inner cylindrical surface of rotor core 54, and/or the radially inner edges of annular spacer 66, between the above-mentioned circumferential, sealed joints (not shown).

Each branch 70 and the trunk 78 to which it is fluidly connected define one of the plurality of interior passages 68 of rotor core 54. In other words, a multiplicity of branches 70 may be fluidly connected to a common trunk 78, with the common trunk 78 and one of its fluidly connected branches 70 defining one of the plurality of rotor core passages 68.

Rotor assembly 26 further includes a plurality of permanent magnets 80, each of which is disposed within a rotor core branch 70. The first and second stacks 58, 60 of carrier laminae 56 thus carry the magnets 80 of rotor core 54. Each magnet 80 may be elongate as shown, and completely surrounded about its length by the enclosing internal wall of the branch 70 in which it is disposed. The magnets 80 and their respective branches 70 may be interference fitted in a known way. For example, the lamina stacks 58, 60 may be heated to expand the cross-sectional sizes of their branches 70, and the respective magnets 80 may be cooled to shrink their cross-sectional sizes. At these altered temperatures, the magnets 80 may be inserted into their respective branches 70 through voids 76. The magnet and lamina stack temperatures would then be allowed to equalize, consequently normalizing the respective magnet and branch cross-sectional sizes and fixing magnets 80 in position relative to their surrounding branches 70 by an interference fit.

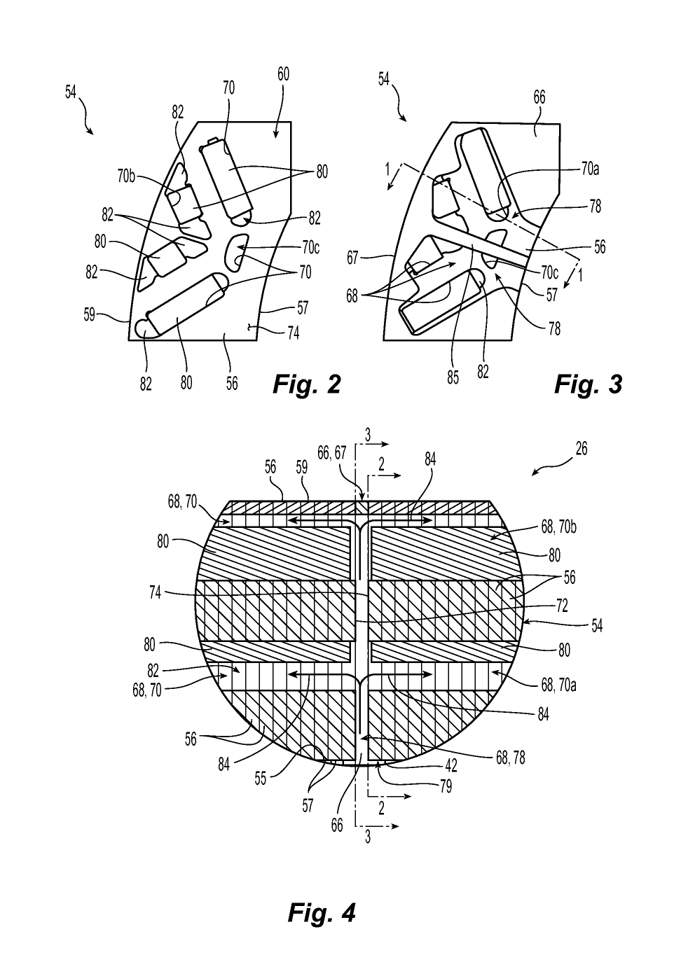

Each magnet 80 and the internal wall of the branch 70 in which it is disposed define a gap 82 along the length of each magnet 80 within its branch 70. Gaps 82 along branches 70a and 70b of second lamina stack 60 are best shown in FIG. 2; gaps 82 in first lamina stack 58 are substantially identical, and are aligned with gaps 82 of second lamina stack 60. The gaps 82 of the first and second lamina stacks 58, 60 are fluidly connected with a respective trunk 78, as shown in FIG. 3. The flow of liquid coolant from each trunk 78 may thus be conducted along a branch 70 through a gap 82, and to a void 76 in an axial end 62, 64 of rotor core 54, as indicated by flow direction arrows 84 in FIGS. 1 and 4. Additionally, coolant may flow from the same trunk 78, into and through third branch 70c which is devoid of a magnet 80, and to a respective void 76.

Pressurized liquid coolant, under the influence of centrifugal force, is forced radially outwardly from one or more hub fluid ducts 44 into groove 79 and a trunk 78. Portions of the coolant received into a trunk 78 are conducted to inlets of branches 70 in inner axial surfaces 72, 74 of the lamina stacks 58, 60. The inlets to first, second, and third branches 70a, 70b, 70c in lamina stack inner axial surfaces 72 and 74 may, like voids 76, be enclosed openings defined by branch-defining apertures in the carrier laminae 56 that define surfaces 72 and 74.

Referring to FIG. 3, a pair of angularly adjacent trunks 78 is separated by a wall portion 85 of distribution lamina 66. A comparison of FIGS. 2 and 3 shows that the angularly adjacent pair of trunks 78 separated by wall 85 (FIG. 3) are both fluidly connected to a single branch, i.e., third branch 70c, in a rotor core lamina stack 58 or 60.

Liquid coolant having flowed axially outwardly from spacer 66 through branches 70 is expelled under pressure through voids 76 in rotor core axial ends 62, 64. First and second rotor core axial ends 62, 64 are respectively sealably covered with first and second manifolds defined by balance rings 86, 88 that rotate in unison with hub 42, to which the balance rings are affixed. The balance rings 86, 88 each define a collection space 90 into which is received liquid coolant expelled from voids 76. Each manifold 86, 88 has a restrictive outlet nozzle 92 from which liquid coolant received into the respective collection space 90 exits the rotor assembly 26 under pressure. The exit nozzles 92 are sized such that they define pressure controlled orifices which restrict the flow of coolant from spaces 90, and thus ensure that the liquid cooling system volume inside rotor assembly 26 remains effectively full of liquid coolant, and that the coolant within the cooling system volume remains pressurized during machine operation. The flow of liquid coolant through the manifolds 86, 88 is indicated by arrows 94 in FIG. 1. The liquid coolant expelled from manifold outlets 92 is received into housing 22. Coolant received into housing 22 exits machine 20 and is cooled before being returned to shaft fluid passageway 34.

While an exemplary embodiment has been disclosed hereinabove, the present disclosure is not limited to the disclosed embodiment. Instead, this application is intended to cover any variations, uses, or adaptations of the present disclosure using its general principles. Further, this application is intended to cover such departures from the present disclosure as come within known or customary practice in the art to which this present disclosure pertains and which fall within the limits of the appended claims.

What is claimed is:

1. A liquid-cooled rotor assembly for a rotary electric machine, comprising:
a rotatively-supportable shaft defining a central axis about which said rotor assembly is rotatable, said shaft provided with a fluid passageway receivable of a liquid coolant;
a substantially cylindrical rotor core disposed about said central axis and rotatable in unison with said shaft, said rotor core having axially opposite ends, said rotor core provided with a plurality of passages, each said rotor core passage terminating at a void in a said rotor core axial end; and
a plurality of permanent magnets distributed about said central axis, each magnet of said plurality of magnets disposed in a said rotor core passage, a gap defined between said each magnet and its respective said rotor core passage, said shaft fluid passageway in fluid communication with said rotor core end voids through said gaps, whereby said rotor core and said plurality of magnets are convectively cooled by liquid coolant receivable by said shaft fluid passageway and delivered to a said rotor core end through said rotor core passages.

2. The rotor assembly of claim 1, wherein said shaft fluid passageway has a generally axially-extending first leg and at least one generally radially-extending second leg, said first leg and a said rotor core end void in fluid communication through said second leg, liquid coolant receivable into said shaft fluid passageway first leg urged from said shaft fluid passageway through said shaft fluid passageway second leg and towards said rotor core passage by rotation of said rotor assembly about said central axis.

3. The rotor assembly of claim 1, further comprising:
a hub disposed radially between and interconnecting said shaft and said rotor core, said hub provided with a fluid duct through which said shaft fluid passageway and a said rotor core passage are fluidly connected.

4. The rotor assembly of claim 3, wherein said hub fluid duct has a generally radially-extending portion along which liquid coolant receivable into said hub fluid duct is urged towards said rotor core by rotation of said rotor assembly about said central axis.

5. The rotor assembly of claim 3, wherein one of said shaft and said hub is provided with a circumferentially-extending groove through which said hub fluid duct and said shaft fluid passageway are fluidly connected.

6. The rotor assembly of claim 1, wherein said plurality of rotor core passages is distributed about said central axis.

7. The rotor assembly of claim 1, wherein each magnet of said plurality of magnets is elongate and entirely surrounded about its length by its respective said rotor core passage.

8. The rotor assembly of claim 1, wherein a said rotor passage includes a generally radially-extending trunk and a generally axially-extending branch, a said magnet disposed in a said rotor core branch.

9. The rotor assembly of claim 8, wherein relative to a said rotor core passage, said trunk and said void are fluidly connected with each other through said branch.

10. The rotor assembly of claim 8, wherein a multiplicity of said rotor core passages includes a multiplicity of said branches and a common said trunk to which said multiplicity of branches is fluidly connected.

11. The rotor assembly of claim 8, wherein a said rotor core passage includes a multiplicity of said trunks and a common said branch with which said multiplicity of trunks is fluidly connected.

12. The rotor assembly of claim 8, wherein said rotor core comprises an axially-stacked plurality of carrier laminae each mutually adjacent to another of said plurality, and at least one distribution lamina axially adjacent said plurality of carrier laminae, said plurality of carrier laminae defining a plurality of said branches, a plurality of said trunks defined by said at least one distribution lamina and at least one said carrier lamina.

13. The rotor assembly of claim 1, further comprising a manifold disposed about said central axis and sealed to a said rotor core end, said manifold defining a collection space into which liquid coolant is receivable from said rotor core end voids, said shaft fluid passageway and said collection space in fluid communication with each other through said plurality of rotor core passages.

14. The rotor assembly of claim 13, wherein a said rotor core end void defines one of a plurality of liquid coolant inlets to said collection space, said manifold having at least one outlet from which liquid coolant is expelled from said collection space.

15. The rotor assembly of claim 14, wherein the total size of said at least one manifold outlet is smaller than the total size of said plurality of inlets to said manifold, whereby said manifold may be pressurized with liquid coolant receivable therein.

16. The rotor assembly of claim 14, wherein each said manifold outlet is a pressure controlled orifice, whereby spaces for liquid coolant in said rotor assembly may remain full of liquid coolant during rotation of said rotor assembly.

17. The rotor assembly of claim 13, wherein said manifold defines a balance ring rotatable in unison with said shaft.

18. A rotary electric machine comprising:
a rotor assembly according to claim 1; and
a stator assembly;
wherein said rotor assembly is surrounded by and rotatable relative to said stator assembly.

19. A method for liquid cooling a rotor assembly in a rotary electric machine, comprising:
receiving liquid coolant into a fluid passageway located in a shaft of the rotor assembly;
rotating a substantially cylindrical rotor core of the rotor assembly and the shaft in unison about an axis;
urging liquid coolant radially outwardly of the shaft and into an internal passage extending through the rotor core;
directing liquid coolant received into the rotor core passage, through a gap defined by a permanent magnet disposed in the rotor core passage and an internal wall of the rotor core passage surrounding the magnet, and out of the rotor core; and
convectively cooling the rotor core and the permanent magnet with liquid coolant directed through the gap.

20. The method of claim 19, further comprising providing a hub radially between the shaft and the rotor core, and fluidly connecting the shaft fluid passageway and the rotor core passage through a fluid duct in the hub.
